(19) United States
(12) Patent Application Publication
(10) Pub. No.: US 2026/0208328 A1
(43) Pub. Date: Jul. 23, 2026

(54) RATCHET WRENCH

(71) Applicant: William Tools Co., Ltd., Taichung City (TW)

(72) Inventor: Shui-Lai Chiang, Taichung City (TW)

(21) Appl. No.: 19/254,235

(22) Filed: Jun. 30, 2025

(30) Foreign Application Priority Data
Jan. 21, 2025 (TW) 114102501

(51) Int. Cl. B25B 13/46; B25B 13/04

(52) U.S. Cl. CPC B25B 13/463; B25B 13/04

(57) ABSTRACT

A ratchet wrench includes: a rod body including a working head including a chamber, and a handle; a ratchet member rotatably received in the chamber; a detent assembly received in the chamber, including first and second detent members and elastic member; and a switching member including a body portion rotatably connected to the working head, and a dial the body portion including an actuating surface; wherein when the dial moves toward a first position, the actuating surface pushes the first detent member to disengage from the ratchet member, and the elastic member urges the second detent member to engage with the ratchet member; wherein when the dial moves toward a second position, the actuating surface pushes the second detent member to disengage from the ratchet member, and the elastic member urges the first detent member to engage with the ratchet member.

### BACKGROUND OF THE INVENTION

### Field of the Invention

The present invention relates to a driving tool, particularly to a ratchet wrench.

### Description of the Prior Art

In general, during fastening operations, hand tools such as ratchet wrenches are used to fasten fasteners, thereby achieving an effect of labor-saving. For example, a socket wrench may be used to loosen/tighten bolts, nuts, or the like. Alternatively, according to different driven members, a driving tool head may be detachably mounted to a coupling of the hand tool.

Typically, a ratchet wrench includes a dial that is switchable to change the rotational direction of the driving head, so as to quickly switch the required driving direction. Conventional ratchet wrenches usually drive a detent assembly to engage a ratchet member disposed on the driving head in different directions through switching of the dial, thereby achieving one-way rotation. However, in the conventional detent assembly, the engagement with the ratchet member is effected by means of an elastic member, which in operation or during dial switching tends to fluctuate elastically and cannot provide strong engagement retention for the detent member. As a result, the engagement between the detent member and the driving head is inaccurate and unreliable, thereby adversely affecting the performance of the ratchet wrench.

The present invention is, therefore, arisen to obviate or at least mitigate the above-mentioned disadvantages.

### SUMMARY OF THE INVENTION

The main object of the present invention is to provide a ratchet wrench that offers stable, effective and reliable engagement performance, thereby improving the operational performance of the ratchet wrench.

To achieve the above and other objects, a ratchet wrench including: a rod body including a working head and a handle, the working head including a chamber; a ratchet member rotatably received in the chamber, having an assembling portion configured to be assembled with a driving member assembly; a detent assembly received in the chamber, including at least one first detent member, at least one second detent member and at least one elastic member between the at least one first detent member and the at least one second detent member; and a switching member including a body portion and a dial, the body portion being rotatably connected to the working head and rotatable about an axis, the body portion including an actuating surface extending about the axis, the dial being located outside the working head and switchable to be located in a first position or in a second position; wherein when the dial moves toward the first position, the actuating surface pushes the at least one first detent member to disengage from the ratchet member, and the elastic member urges the at least one second detent member to engage with the ratchet member; wherein when the dial moves toward the second position, the actuating surface pushes the at least one second detent member to disengage from the ratchet member, and the elastic member urges the at least one first detent member to engage with the ratchet member.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is a partial exploded view of an exemplary embodiment of the present invention;

FIG. 3 is another partial exploded view of an exemplary embodiment of the present invention;

FIG. 4 is a cross-sectional view of an exemplary embodiment of the present invention; and

FIG. 5 is another cross-sectional view of an exemplary embodiment of the present invention.

### DETAILED DESCRIPTION OF THE PREFERRED EMBODIMENTS

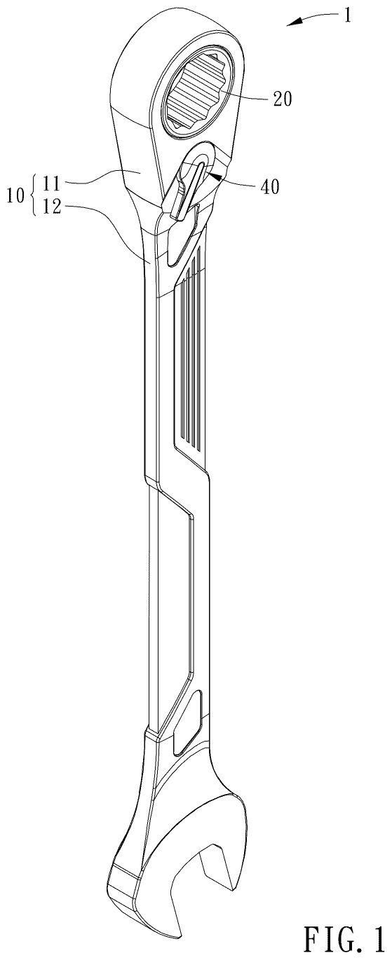

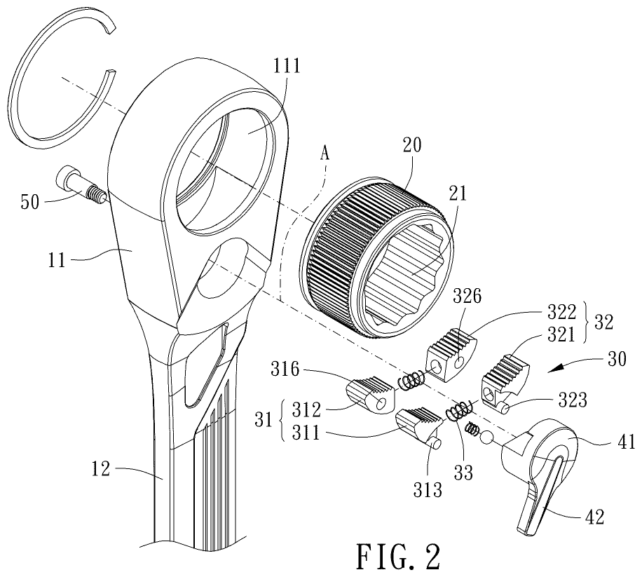

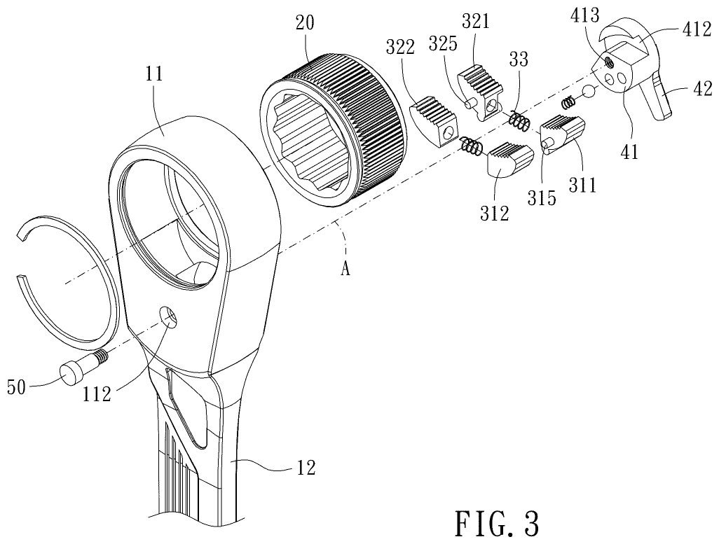

Please refer to FIGS. 1 to 5 for an exemplary embodiment of the present invention. A ratchet wrench 1 of the present invention includes a rod body 10, a ratchet member 20, a detent assembly 30 and a switching member 40.

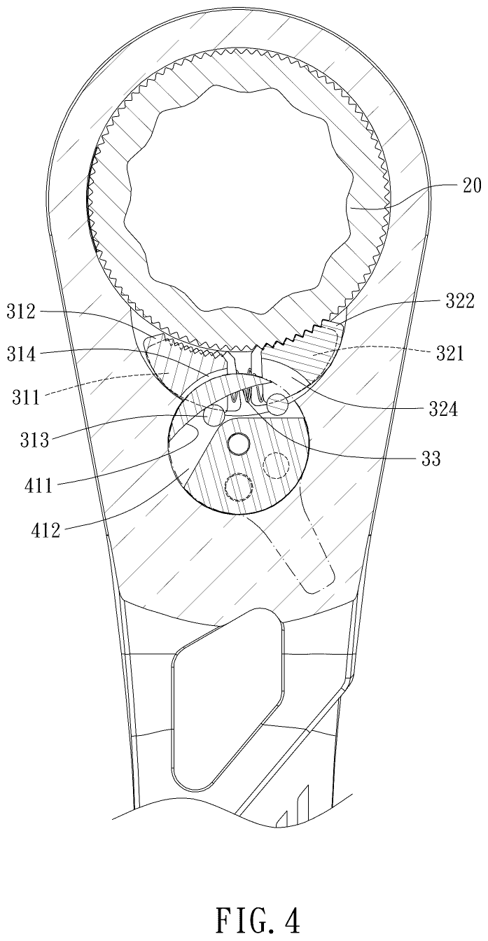

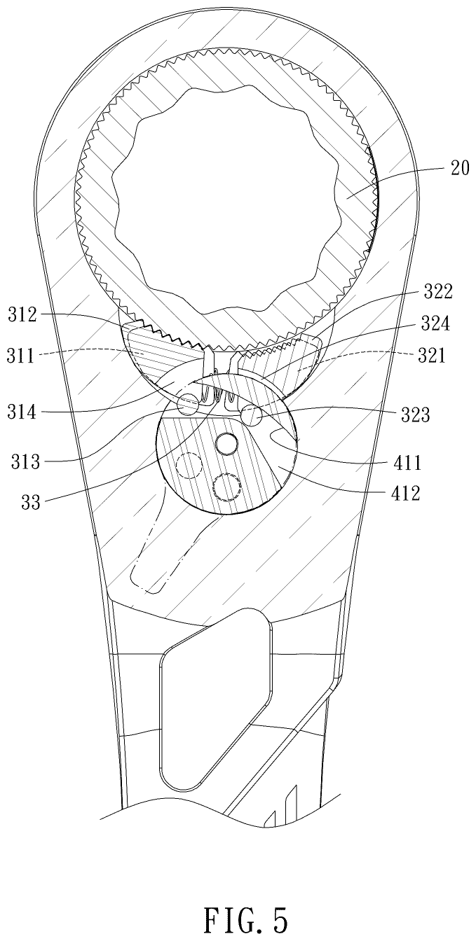

The rod body 10 includes a working head 11 and a handle 12. The working head 11 includes a chamber 111. The ratchet member 20 is rotatably received in the chamber 111. The ratchet member 20 includes an assembling portion 21 configured to be assembled with a driving member (such as a socket, extension bar, tool head, etc.), which may be a male projection or a female recess. The detent assembly 30 is received in the chamber 111 and includes at least one first detent member 31, at least one second detent member 32, and at least one elastic member 33 between the at least one first detent member 31 and the at least one second detent member 32. The detent assembly 30 is configured to restrict the ratchet member 20 to one-way rotation. The switching member 40 includes a body portion 41 and a dial 42. The body portion 41 is pivotally connected to the working head 11 and rotatable about an axis a. The body portion 41 includes an actuating surface 411 extending about the axis A. The dial 42 is located outside the working head 11 and is switchable between a first position (FIG. 4) and a second position (FIG. 5). When the dial 42 moves toward the first position, the actuating surface 411 pushes the at least one first detent member 31 to disengage from the ratchet member 20, and the elastic member 33 urges the at least one second detent member 32 to engage with the ratchet member 20. When the dial 42 moves toward the second position, the actuating surface 411 pushes the at least one second detent member 32 to disengage from the ratchet member 20, and the elastic member 33 urges the at least one first detent member 31 to engage with the ratchet member 20. Thereby, stable, effective and reliable detent engagement is achieved, and operational performance of the ratchet wrench 1 is enhanced.

The at least one first detent member 31 includes a first upper detent member 311 and a first lower detent member 312 which are vertically stacked and movable with each other. Similarly, the at least one second detent member 32 includes a second upper detent member 321 and a second lower detent member 322 which are vertically stacked and movable with each other. The double-layer detent structure enhances the engagement effect, stability and reliability of the detent assembly 30 with the ratchet member 20.

Specifically, the first upper detent member 311 includes a first column 313 and a first slot 314 extending around the first column 313. When the dial 42 moves toward the first position, the actuating surface 411 moves within the first slot 314 and pushes the first column 313 to move in a direction away from the ratchet member 20, so that the at least one first detent member 31 disengages from the ratchet member 20. At this time, only the at least one second detent member 32 engages the ratchet member 20, thereby allowing one-way rotation of the ratchet member 20. The second upper detent member 321 includes a second column 323 and a second slot 324 extending around the second column 323. When the dial 42 moves toward the first position, the actuating surface 411 moves within the second slot 324 and pushes the second column 323 to move in a direction away from the ratchet member 20, so that the at least one second detent member 32 disengages from the ratchet member 20. At this time, only the at least one first detent member 31 engages the ratchet member 20, thereby allowing one-way rotation of the ratchet member 20.

Specifically, one of the first upper detent member 311 and the first lower detent member 312 includes a first plug 315, and the other of the first upper detent member 311 and the first lower detent member 312 includes a first hole 316. The first plug 315 is inserted in the first hole 316. In this embodiment, the first upper detent member 311 includes the first plug 315, and the first lower detent member 312 includes the first hole 316. One of the second upper detent member 321 and the second lower detent member 322 includes a second plug 325, and the other of the second upper detent member 321 and the second lower detent member 322 includes a second hole 326. The second plug 325 is inserted in the second hole 326. In this embodiment, the second upper detent member 321 includes the second plug 325, and the second lower detent member 322 includes the second hole 326.

Specifically, the actuating surface 411 is a concave surface and extends within both the first slot 314 and the second slot 324. Preferably, a length of the actuating surface 411 is greater than a distance between respective outermost ends of the first column 313 and the second column 323, which facilitates stabilization of the detent assembly 30. When the dial 42 moves toward the first position and the first column 313 moves in a direction away from the ratchet member 20, detent teeth of the first upper detent member 311 and the first lower detent member 312 are in a state of peak-to-valley alignment (FIG. 4). When the dial 42 moves toward the second position and the second column 323 moves in a direction away from the ratchet member 20, detent teeth of the second upper detent member 321 and the second lower detent member 322 are in a state of peak-to-valley alignment (FIG. 5). As such, a denser tooth arrangement is provided, and the feed stroke of the detent assembly 30 during switching can be significantly reduced, which effectively prevents reverse rotation of the ratchet member 20 under load during operation.

Specifically, a length and a width of the first upper detent member 311 are smaller than a length and a width of the first lower detent member 312, respectively. A diametric dimension of the first hole 316 is greater than a diametric dimension of the first plug 315, respectively, providing a clearance for relative movement between the first upper detent member 311 and the first lower detent member 312, such that both can engage the ratchet member 20 more effectively. A length and a width of the second upper detent member 321 are smaller than a length and a width of the second lower detent member 322. A diametric dimension of the second hole 326 is greater than a diametric dimension of the second plug 325, providing a clearance for relative movement between the second upper detent member 321 and the second lower detent member 322, such that both can engage the ratchet member 20 more effectively. The body portion 41 further includes a through groove 412. A groove wall of the through groove 412 includes the actuating surface 411. The through groove 412 extends around the axis A and gradually widens toward two opposite sides of the body portion 41 to prevent interference with the actuation of the first column 313 and the second column 323.

In this embodiment, the body portion 41 of the switching member 40 is inserted in a side wall of the working head 11. Another side wall of the working head 11 opposite to the switching member 40 includes a through hole 112. The body portion 41 of the switching member 40 further includes a pivot hole 413. A shaft 50 passes through the through hole 112 and is inserted in the pivot hole 413. The switching member 40 is rotatable about the shaft 50. Preferably, the shaft 50 is screwed to the body portion 41 of the switching member 40, which is conducive to assembly, replacement and maintenance.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A ratchet wrench including:
a rod body including a working head and a handle, the working head including a chamber;
a ratchet member rotatably received in the chamber, having an assembling portion configured to be assembled with a driving member assembly;
a detent assembly received in the chamber, including at least one first detent member, at least one second detent member and at least one elastic member between the at least one first detent member and the at least one second detent member; and
a switching member including a body portion and a dial, the body portion being rotatably connected to the working head and rotatable about an axis, the body portion including an actuating surface extending about the axis, the dial being located outside the working head and switchable to be located in a first position or in a second position;
wherein when the dial moves toward the first position, the actuating surface pushes the at least one first detent member to disengage from the ratchet member, and the elastic member urges the at least one second detent member to engage with the ratchet member;
wherein when the dial moves toward the second position, the actuating surface pushes the at least one second detent member to disengage from the ratchet member, and the elastic member urges the at least one first detent member to engage with the ratchet member.

2. The ratchet wrench of claim 1, wherein the actuating surface is a concave surface.

3. The ratchet wrench of claim 1, wherein the at least one first detent member includes a first upper detent member and a first lower detent member which are vertically stacked and movable with each other.

4. The ratchet wrench of claim 3, wherein the first upper detent member includes a first column and a first slot extending around the first column, and when the dial moves toward the first position, the actuating surface moves within the first slot and pushes the first column to move in a direction away from the ratchet member.

5. The ratchet wrench of claim 4, wherein one of the first upper detent member and the first lower detent member includes a first plug, the other of the first upper detent member and the first lower detent member includes a first hole, and the first plug is inserted in the first hole.

6. The ratchet wrench of claim 1, wherein the at least one second detent member includes a second upper detent member and a second lower detent member which are vertically stacked and movable with each other.

7. The ratchet wrench of claim 6, wherein the second upper detent member includes a second column and a second slot extending around the second column, and when the dial moves toward the first position, the actuating surface moves within the second slot and pushes the second column to move in a direction away from the ratchet member.

8. The ratchet wrench of claim 7, wherein one of the second upper detent member and the second lower detent member includes a second plug, and the other of the second upper detent member and the second lower detent member includes a second hole, and the second plug is inserted in the second hole.

9. The ratchet wrench of claim 5, wherein the at least one second detent member includes a second upper detent member and a second lower detent member which are vertically stacked and movable with each other; when the dial moves toward the first position and the first column moves in a direction away from the ratchet member, detent teeth of the first upper detent member and the first lower detent member are in a state of peak-to-valley alignment; the second upper detent member includes a second column and a second slot extending around the second column, and when the dial moves toward the second position, the actuating surface moves within the second slot and pushes the second column to move in a direction away from the ratchet member, and detent teeth of the second upper detent member and the second lower detent member are in a state of peak-to-valley alignment; the actuating surface is a concave surface and extends within the first slot and the second slot; one of the second upper detent member and the second lower detent member includes a second plug, and the other of the second upper detent member and the second lower detent member includes a second hole, and the second plug is inserted into the second hole; a length of the actuating surface is greater than a distance between respective outermost ends of the first column and the second column; a diametric dimension of the first hole is greater than a diametric dimension of the first plug; a diametric dimension of the second hole is greater than a diametric dimension of the second plug; a length and a width of the first upper detent member are smaller than a length and a width of the first lower detent member, respectively; a length and a width of the second upper detent member are smaller than a length and a width of the second lower detent member, respectively; the body portion further includes a through groove extending around the axis and gradually widening in directions respectively toward two opposite sides of the body portion, and a groove wall of the through groove includes the actuating surface.

10. The ratchet wrench of claim 1, wherein the body portion of the switching member is inserted in a side wall of the working head, another side wall of the working head opposite to the switching member includes a through hole, the body portion of the switching member further includes a pivot hole, and a shaft passes through the through hole and is inserted in the pivot hole.
